(19) United States
(12) Patent Application Publication
(10) Pub. No.: US 2012/0311264 A1
(43) Pub. Date: Dec. 6, 2012

(54) DATA MANAGEMENT METHOD, DEVICE, AND DATA CHIP

(75) Inventors: Hua WEI, Chngdu (CN); Qin Zheng, Boxborough, MA (US); Wenhua Du, Shenzhen (CN)

(73) Assignee: Huawei Technologies Co., Ltd.

(21) Appl. No.: 13/483,331

(22) Filed: May 30, 2012

Related U.S. Application Data
(63) Continuation of application No. PCT/CN2011/075026, filed on May 31, 2011.

(51) Int. Cl. G06F 12/08

(52) U.S. Cl. 711/118; 711/E12.017

(57) ABSTRACT

The present invention discloses a data management method, device and data chip. The data management method includes: receiving write data of a write request; writing the write data according to a current data management mode, where when the data management mode is a first mode, the write data of the write request is stored in an on-chip cache and when the data management mode is a second mode, the write data of the write request is stored in the on-chip cache and an off-chip memory chip; and receiving a read request of the write data, searching for the write data in the on-chip cache according to the read request, and if the write data cannot be obtained from the on-chip cache, obtaining the write data from the off-chip memory chip, thereby reducing power consumption for data access to external memory chips.

### CROSS-REFERENCE TO RELATED APPLICATIONS

This application is a continuation of International Application No. PCT/CN2011/075026, filed on May 31, 2011, which is hereby incorporated by reference in their entireties.

### FIELD OF THE INVENTION

The present invention relates to the field of communications technologies, and in particular, to a data management method, device, and data chip.

### BACKGROUND OF THE INVENTION

In a data network, large quantities of DRAM (Dynamic Random Access Memory, dynamic random access memory) devices like a DDR RAM (Double Data Rate Random Access Memory, double data rate random access memory) or RLDRAM (Reduced Latency Dynamic Random Access Memory, reduce latency dynamic random access memory) are usually needed to provide off-chip data cache space. As a result, with the increase of traffic, the power consumption for a DRAM controller to access these off-chip DRAMs will be larger and larger.

At present, the usual practice is to embed a cache in the DRAM controller and write data in write through mode, where data is stored not only in the Cache but also in an off-chip DRAM. When a read data request comes, if the requested data is still in the Cache, that is the data is not overwritten by subsequent data, the data is read from the Cache without the need to access the off-chip DRAM. Therefore, to some extent, the power consumption for accessing the off-chip DRAM in the data reading direction is saved and the read latency is reduced. However, because data is written in Write Through mode, the power consumption for accessing the off-chip DRAM in the data writing direction cannot be saved.

### SUMMARY OF THE INVENTION

The purpose of the present invention is to provide a data management method, device, and data chip, to reduce the power consumption of data access.

The purpose of the present invention is realized through the following technical solutions:

A data management method includes:

receiving write data of a write request;

writing the write data according to a current data management mode, where when the data management mode is a first mode, the write data of the write request is stored in an on-chip cache and when the data management mode is a second mode, the write data of the write request is stored in the on-chip cache and an off-chip memory chip; and

receiving a read request of the write data, searching for the write data in the on-chip cache according to the read request, and if the write data cannot be obtained from the on-chip cache, obtaining the write data from the off-chip memory chip.

A data management device includes:

a determining unit, configured to determine a data management mode according to an occupation rate of an on-chip cache or a priority of read or write data, where the data management mode includes a first management mode and a second management mode;

a write request processing unit, configured to process a write request according to the data management mode, where when the data management mode is the first management mode, the write request processing unit writes write data of the write request in the on-chip cache and when the data management mode is the second management mode, the write request processing unit writes write data of the write request in the on-chip cache and an off-chip memory chip; and

a read request processing unit, configured to: after receiving a read request, search for read data of the read request in the on-chip cache, and if the read data does not exist in the on-chip cache, obtain the read data from the off-chip memory chip.

A data chip includes:

an on-chip cache, configured to store read or write data;

a determining unit, configured to determine a data management mode according to an occupation rate of the on-chip cache or a priority of the read or write data, where the data management mode includes a first management mode and a second management mode;

a write request processing unit, configured to process a write request according to the data management mode, where when the data management mode is the first management mode, the write request processing unit writes write data of the write request in the on-chip cache and when the data management mode is the second management mode, the write request processing unit writes write data of the write request in the on-chip cache and an off-chip memory chip; and

a read request processing unit, configured to: after receiving a read request, search for read data of the read request in the on-chip cache, and if the read data does not exist in the on-chip cache, obtain the read data from the off-chip memory chip.

As seen from the above technical solutions provided by the present invention, the data management mode is determined, and in the first mode, the write data is stored in the on-chip cache and the read data is obtained from the on-chip cache without the need to access the off-chip memory chip, thereby saving power consumption for accessing the off-chip memory chip in a data writing direction and a data reading direction. In the second mode, the write data is stored in the on-chip cache and the off-chip memory chip, and if the data of the read request is in the on-chip cache, that is, the data is not overwritten by subsequent data, the data is read from the on-chip cache, thereby saving power consumption for accessing the off-chip memory chip in a data reading direction.

### BRIEF DESCRIPTION OF THE DRAWINGS

FIG. 1 is a schematic flowchart of a data management method according to an embodiment of the present invention;

FIG. 2 is a first schematic composition diagram of a data management device according to an embodiment of the present invention;

FIG. 3 is a second schematic composition diagram of a data management device according to an embodiment of the present invention;

FIG. 4 is a schematic composition diagram of a memory controller according to an embodiment of the present invention;

FIG. 5A and FIG. 5B are a schematic composition diagram of a data management device in an application scenario according to an embodiment of the present invention;

FIG. 6 is a first schematic flowchart of a data management method in an application scenario according to an embodiment of the present invention; and

FIG. 7 is a second schematic flowchart of a data management method in an application scenario according to an embodiment of the present invention.

### DETAILED DESCRIPTION OF THE EMBODIMENTS

The embodiments of the present invention are hereinafter described in detail with reference to the accompanying drawings.

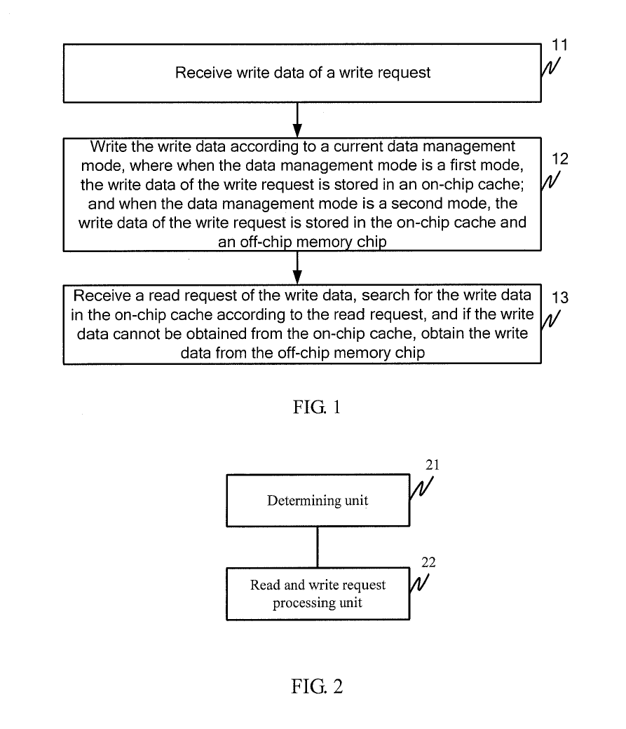

As shown in FIG. 1, an embodiment of the present invention provides a data management method, including the following steps:

11. Receive write data of a write request.

12. Write the write data according to a current data management mode.

When the data management mode is a first mode, the write data of the write request is stored in an on-chip cache; when the data management mode is a second mode, the write data of the write request is stored in the on-chip cache and an off-chip memory chip.

13. Receive a read request of the write data, search for the write data in the on-chip cache according to the read request, and if the write data cannot be obtained from the on-chip cache, obtain the write data from the off-chip memory chip.

The executer of the data management method in the embodiment of the present invention may be a memory controller, for example, a DRAM controller. The off-chip memory chip (or referred to be as an off-chip memory) is an off-chip DRAM such as a DDRRAM and an RLDRAM.

As seen from the above technical solutions provided by the present invention, the data management mode is determined, and in the first mode, the write data is stored in the on-chip cache and the read data is obtained from the on-chip cache without the need to access the off-chip memory, thereby saving power consumption for accessing the off-chip memory in a data writing direction and a data reading direction. In the second mode, the write data is stored in the on-chip cache and the off-chip memory, and if the data of the read request is in the on-chip cache, that is, the data is not overwritten by subsequent data, the data is read from the on-chip cache, thereby saving power consumption for accessing the off-chip memory in a data reading direction.

Optionally, the determining the data management mode in step 11 may include:

determining the data management mode according to the occupation rate of the on-chip cache;

or, determining the data management mode according to a data priority, where the data priority includes a high priority or a low priority.

Specifically, the determining the data management mode according to the occupation rate of the on-chip cache may include:

determining the data management mode according to a relationship between the occupation rate of the on-chip cache and a preset threshold.

Exemplarily, if the occupation rate of the on-chip cache is less than the preset threshold, the memory controller determines that the data management mode is the first mode; if the occupation rate of the on-chip cache is greater than the preset threshold, the memory controller determines that the data management mode is the second mode.

Preferably, to avoid frequent switching between the first mode and the second mode, the determining the data management mode according to the occupation rate of the on-chip cache by the memory controller may include:

when the occupation rate of the on-chip cache is less than or equal to a first threshold, determining that the data management mode is the first mode;

when the occupation rate of the on-chip cache rises to be equal to or greater than the first threshold, determining that the data management mode is switched from the first mode to the second mode;

when the occupation rate of the on-chip cache returns to be less than or equal to a second threshold, determining that the data management mode is switched from the second mode to the first mode.

The first threshold is greater than the second threshold.

Obviously, there is a difference between the first threshold and the second threshold, thereby avoiding frequent switching between the first mode and the second mode once the occupation rate of the on-chip cache changes when one threshold is used.

It is understandable that, when the occupation rate of the on-chip cache is less than the first threshold, the data management mode is the first mode, and when the occupation rate of the on-chip cache rises to be equal to or greater than the first threshold, it is determined that the data management mode is switch from the first mode to the second mode; when the occupation rate of the on-chip cache is equal to the first threshold, the data management mode is the first mode, and when the occupation rate of the on-chip cache rises to be greater than the first threshold, it is determined that the data management mode is switch from the first mode to the second mode.

Obviously, when it is determined that the data management mode is the first mode according to the occupation rate of the on-chip cache, the cache capability of the on-chip cache can be fully utilized, and the memory controller does not access the off-chip DRAM at all, thereby saving power consumption for accessing the off-chip DRAM in a writing direction and a reading direction, and realizing short read/write delay.

In addition, specifically, the determining the data management mode according to the data priority includes:

when the data priority is a high priority, determining that the data management mode is the first mode; and

when the data priority is a low priority, determining that the data management mode is the second mode.

Optionally, a data packet carries data priority information. For example, VoIP (Voice over Internet Protocol, Voice over Internet Protocol), and IPTV (Internet Protocol Television, Internet Protocol Television) are high priority services and a corresponding data packet may carry high priority information; an Internet service is low a priority service and a corresponding data packet may carry low priority information. Furthermore, to guarantee a high priority service, a high priority data packet features short read/write delay.

Therefore, according to the short read/write delay of the high priority data packet, when a data priority is a high priority, it is determined that the data management mode is the first mode. In this way, the cache capability of the on-chip cache can be fully utilized to read or write high priority data, and the memory controller does not access the off-chip DRAM at all, thereby saving power consumption for accessing the off-chip DRAM in a writing direction and a reading direction. Moreover, when the data priority is a low priority, it is determined that the data management mode is the second mode. Low priority data may not occupy the on-chip cache for a long time, thereby avoiding a problem that high and low priority data cannot be written in the on-chip cache because the low priority data occupies the on-chip cache.

In addition, optionally, the determining the data management mode according to the data priority may include:

when the data priority is a high priority and the occupation rate of the on-chip cache is equal to or greater than the first threshold, determining that the data management mode is the second mode.

Obviously, even if a priority of data is high according to a data packet, as long as the occupation rate of the on-chip cache is already relatively high, high priority data still needs to be written in Write Through mode and when read data cannot be obtained from the on-chip cache, the read data is obtained from the off-chip memory.

In a word, the determining the data management mode according to the occupation rate of the on-chip cache is to implement the switching between the first mode and the second mode automatically with the change of the occupation rate of the on-chip cache, which is referred to be as the automatic switching mode of the data management mode.

The determining the data management mode according to the data priority is to implement the switching between the first mode and the second mode automatically according to the data priority, which is referred to be as the priority awareness mode of the data management mode.

Further, it can be known that no matter whether the data management mode is in the automatic switching mode or priority awareness mode, the data management mode may include the first mode or the second mode.

Optionally, the automatic switching mode and the priority awareness mode may be configured statically according to a user requirement or data traffic predicted by a user.

Specifically, when it is predicted that data traffic may not be congested, the automatic switching mode can be configured. Exemplarily, in a practical network operation, data traffic is not in congestion for most of the time, for example, only less than 100 G traffic is flowing in a 200 G line card, and the cache capability of the on-chip cache is enough to meet a requirement. In this way, according to the occupation rate of the on-chip cache, the automatic switching between the first mode and the second mode can be implemented dynamically.

When it is predicted that data traffic may be congested, the priority awareness mode may be configured. In this way, low priority data may not occupy the on-chip cache for a long time, and the cache capability of the on-chip cache can be fully utilized by high priority data, thereby saving power consumption for accessing the off-chip memory in a data writing direction and a data reading direction.

Optionally, whether data traffic is congested may be predicted according to the position of the memory controller in a data network.

In addition, the data management method in the embodiment of the present invention may judge, according to the occupation rate of the on-chip cache, whether data traffic is congested.

If the data traffic is not congested, the read/write request delay is short and data may be read quickly from the on-chip cache, and therefore the occupation rate of the on-chip cache is always kept at a low level.

Conversely, if the data traffic is congested, the read/write request delay is long, and the occupation rate of the on-chip cache is at a high level.

The memory controller is sensitive to the read/write request delay. The delay is caused by congestion of the data traffic, and the delay is further reflected by the occupation rate of the on-chip cache.

Optionally, in step 13, the obtaining the read data of the read request from the on-chip cache preferably when the data management mode is the second mode, and when the read data of the read request cannot be obtained from the on-chip cache, obtaining the read data of the read request from the off-chip memory may include:

when the data management mode is the second mode, after receiving the read request, judging whether the read data of the read request can be obtained from the on-chip cache;

if the read data of the read request can be obtained from the on-chip cache, obtaining the read data of the read request from the on-chip cache; and

if the read data of the read request cannot be obtained from the on-chip cache, obtaining the read data of the read request from the off-chip memory.

Obviously, when the data management mode is the second mode, write data is stored in the on-chip cache and the off-chip memory. When the read request is received, if requested data is still in the on-chip cache, that is, the data is not overwritten by subsequent data, the read data is obtained from the on-chip cache preferably, thereby saving power consumption for accessing the off-chip memory in a data reading direction. If the data of the read request is not in the on-chip cache, and the read data cannot be obtained from the on-chip cache, the read data is obtained from the off-chip memory.

As shown in FIG. 2, corresponding to the data management method in the above embodiment of the present invention, an embodiment of the present invention provides a data management device, including:

a determining unit 21, configured to determine a data management mode according to an occupation rate of an on-chip cache or a priority of read or write data, where the data management mode includes a first management mode and a second management mode; and

a read and write request processing unit 22, formed by a read request processing unit and a write request processing unit, and configured to process reading of data of a read request and writing of data of a write request according to the data management mode.

When the data management mode is the first management mode, the write request processing unit writes write data of a write request in the on-chip cache; when the data management mode is the second management mode, the write request processing unit writes write data of a write request in the on-chip cache and an off-chip memory chip. The read request processing unit is configured to: after receiving a read request, search for read data of the read request in the on-chip cache and if the read data does not exist in the on-chip cache, obtain the read data from the off-chip memory chip.

The data management device in the embodiment of the present invention may be disposed independently or disposed together with a memory controller, such as a DRAM controller. The off-chip memory chip (or referred to be as an off-chip memory) is an off-chip DRAM such as a DDRRAM and an RLDRAM.

As seen from the above technical solutions provided by the present invention, in the first mode, the write data is stored in the on-chip cache and the read data is obtained from the on-chip cache without the need to access the off-chip memory, thereby saving power consumption for accessing the off-chip memory in a data writing direction and a data reading direction. In the second mode, the write data is stored in the on-chip cache and the off-chip memory, and if the data of the read request is in the on-chip cache, that is, the data is not overwritten by subsequent data, the data is read from the on-chip cache, thereby saving power consumption for accessing the off-chip memory in a data reading direction; if the data of the read request is not in the on-chip cache and the read data cannot be obtained from the on-chip cache, the read data is obtained from the off-chip memory.

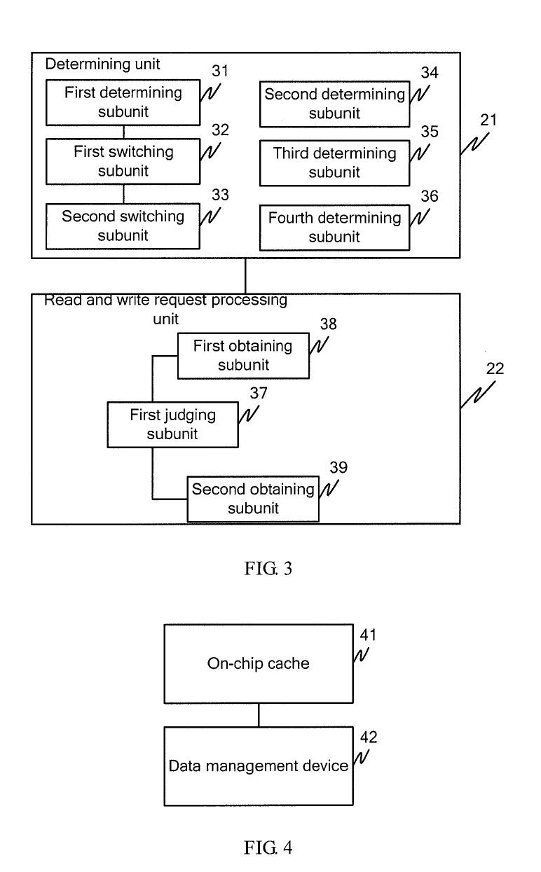

Specifically, as shown in FIG. 3, when the determining unit 21 is specifically configured to determine the data management mode according to the occupation rate of the on-chip cache, the determining unit 21 may include:

a first determining subunit 31, configured to determine that the data management mode is the first mode when the occupation rate of the on-chip cache is less than or equal to a first threshold;

a first switching subunit 32, configured to determine that the data management mode is switched from the first mode to the second mode when the occupation rate of the on-chip cache rises to be equal to or greater than the first threshold; and

a second switching subunit 33, configured to determine that the data management mode is switched from the second mode to the first mode when the occupation rate of the on-chip cache returns to be less than or equal to a second threshold.

The first threshold is greater than the second threshold.

Or, when the determining unit 21 is specifically configured to determine the data management mode according to a data priority, the determining unit 21 may include:

a second determining subunit 34, configured to determine that the data management mode is the first mode when the data priority is a high priority; and

a third determining subunit 35, configured to determine that the data management mode is the second mode when the data priority is a low priority.

Or, when the determining unit 21 is specifically configured to determine the data management mode according to a data priority, the determining unit 21 may include:

a fourth determining subunit 36, configured to determine that the data management mode is the second mode when the data priority is a high priority and the occupation rate of the on-chip cache is equal to or greater than the first threshold.

Optionally, the read and write request processing unit 22 may include:

a first judging subunit 37, configured to, when the data management mode is the second mode, judge whether read data of a read request can be obtained from the on-chip cache, after the read request is received;

a first obtaining subunit 38, configured to obtain the read data of the read request from the on-chip cache when the first judging subunit 37 judges that the read data of the read request can be obtained from the on-chip cache; and

a second obtaining subunit 39, configured to obtain the read data of the read request from the off-chip memory when the first judging subunit 37 judges that the read data of the read request cannot be obtained from the on-chip cache.

The data management device and its components in the embodiment of the present invention can be understood with reference to the corresponding content of the data management method in the foregoing embodiment of the present invention, and details are not further described herein.

Corresponding to the data management device in the foregoing embodiment of the present invention, an embodiment of the present invention provides a data chip, including:

an on-chip cache, configured to store read or write data;

a determining unit, configured to determine a data management mode according to an occupation rate of the on-chip cache or a priority of the read or write data, where the data management mode includes a first management mode and a second management mode; and

a read and write request processing unit, configured to process reading of data of a read request and writing of data of a write request according to the data management mode, where when the data management mode is the first management mode, the read and write request processing unit writes write data of a write request in the on-chip cache and searches for read data of a read request in the on-chip cache; when the data management mode is the second management mode, the read and write request processing unit writes write data of a write request in the on-chip cache and an off-chip memory chip, and when the read and write request processing unit receives the read request, the read and write request processing unit first searches for read data in the on-chip cache, and if the read data does not exist in the on-chip cache, the read and write request processing unit obtains the read data from the off-chip memory chip.

Specifically, the determining unit may include:

a first determining subunit, configured to determine that the data management mode is the first mode when the occupation rate of the on-chip cache is less than or equal to a first threshold; or

a first switching subunit, configured to determine that the data management mode is switched from the first mode to the second mode when the occupation rate of the on-chip cache rises to be equal to or greater than a first threshold; or

a second switching subunit, configured to determine that the data management mode is switched from the second mode to the first mode when the occupation rate of the on-chip cache returns to be less than or equal to a second threshold.

The first threshold is greater than the second threshold.

Or, the determining unit may include:

a second determining subunit, configured to determine that the data management mode is the first mode when a data priority is a high priority; or

a third determining subunit, configured to determine that the data management mode is the second mode when a data priority is a low priority.

Or, the determining unit may include:

a fourth determining subunit, configured to determine that the data management mode is the second mode when a data priority is a high priority and the occupation rate of the on-chip cache is equal to or greater than the first threshold.

As seen from the above technical solutions provided by the present invention, the data management mode is determined, and in the first mode, the write data is stored in the on-chip cache and the read data is obtained from the on-chip cache without the need to access the off-chip memory, thereby saving power consumption for accessing the off-chip memory in a data writing direction and a data reading direction. In the second mode, the write data is stored in the on-chip cache and the off-chip memory, and if the data of the read request is in the on-chip cache, that is, the data is not overwritten by subsequent data, the data is read from the on-chip cache, thereby saving power consumption for accessing the off-chip memory in a data reading direction.

The data management device and its components in the embodiment of the present invention can be understood with reference to the corresponding content of the data management device in the foregoing embodiment of the present invention, and details are not further described herein.

As shown in FIG. 4, an embodiment of the present invention provides a memory controller, including an on-chip cache 41 and a data management device 42.

The on-chip cache 41 is configured to store read or write data.

The data management device 42 is configured to determine a data management mode according to an occupation rate of the on-chip cache 41 or a priority of the read or write data, where the data management mode includes a first management mode and a second management mode; and is configured to process reading of data of a read request and writing of data of a write request according to the data management mode, where when the data management mode is the first management mode, a read and write request processing unit writes write data of a write request in the on-chip cache 41 and searches for read data of a read request in the on-chip cache 41; when the data management mode is the second management mode, a read and write request processing unit writes write data of a write request in the on-chip cache 41 and an off-chip memory chip; and when the read and write request processing unit receives a read request, the read and write request processing unit first searches for read data in the on-chip cache 41, and if the read data does not exist in the on-chip cache, the read and write request processing unit obtains the read data from the off-chip memory chip.

The memory controller in the embodiment of the present invention is, for example, a DRAM controller. The off-chip memory chip (or referred to be as an off-chip memory) is an off-chip DRAM such as a DDRRAM and an RLDRAM.

As seen from the above technical solutions provided by the present invention, in the first mode, the write data is stored in the on-chip cache and the read data is obtained from the on-chip cache without the need to access the off-chip memory, thereby saving power consumption for accessing the off-chip memory in a data writing direction and a data reading direction. In the second mode, the write data is stored in the on-chip cache and the off-chip memory, and if the data of the read request is in the on-chip cache, the data is read from the on-chip cache, to save power consumption for accessing the off-chip memory in a data reading direction; and when the read data cannot be obtained from the on-chip cache, the read data is obtained from the off-chip memory.

The memory controller and its components in the embodiment of the present invention can be understood with reference to the corresponding content of the data management device in the foregoing embodiment of the present invention, and details are not further described herein.

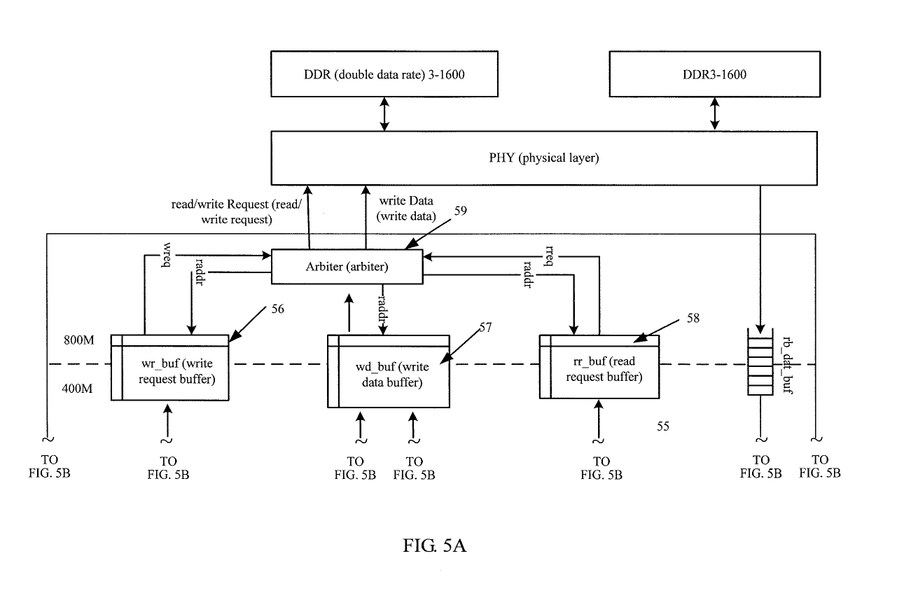

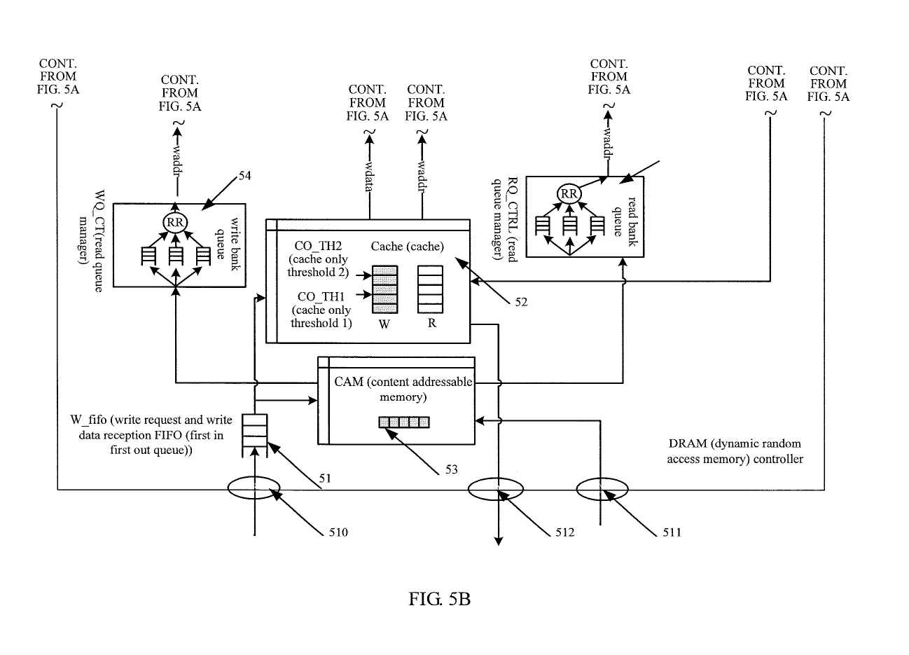

Specifically, as shown in FIG. 5A and FIG. 5B, an embodiment of the present invention provides a DRAM controller, including the following modules:

w_fifo51: a write request and write data receiving FIFO (First Input First Output, first input first output queue);

Cache52: an on-chip read or write data cache of the DRAM controller, where the cache is divided into two caches of the same capacity, one cache is a write data cache for use of a write request, and the other cache is a read data cache for use of a read request;

CAM (Content Addressable Memory, content addressable memory) 53: its depth is the same as the write data cache in the Cache, where an addressing key is an off-chip DRAM address of data and if the key is hit, the output result (the address of the CAM) corresponds to the address of the write data cache in the Cache;

WQ_CTRL54: a BANK write request queue managing module, where for any write request entering the queue, a write operation application needs to be sent to the off-chip DRAM;

RQ_CTRL55: a BANK read request queue managing module, where for any write request entering the queue, a read operation application needs to be sent to the off-chip DRAM;

wr_buf module 56, wd_buf module 57, and rr_buf module 58: asynchronous RAM (Random Access Memory);

where, the wr_buf module stores a write request, the wd_buf module stores write data, and the rr_buf module stores a read request; and

Arbiter59: a DDR access arbiter which obtains read and write requests from the asynchronous RAM and sends read and write commands to a PHY (Physical Layer, physical layer).

Further, the DRAM controller in the embodiment of the present invention provides the following user side interfaces:

a first interface 510: a write interface through which a user sends write data and the off-chip DRAM address of the write data to the DRAM controller;

a second interface 511: an off-chip read request interface through which the user sends a read request and requests the DRAM controller to read data from the off-chip DRAM back to the DRAM controller (the user does not learn whether the data is on chip or off chip, and the data is off chip by default); and

a third interface 512: a data bus interface, configured to read data from an on-chip cache directly after a read request is received if a CAM query is hit, and send the data back to the user through the data bus interface; otherwise, send the data to the user through the data bus interface after the data is returned from the off-chip DRAM.

A data management mode of the DRAM controller in the embodiment of the present invention is preset to an automatic switching mode, and specifically, according to an occupation rate of the Cache, the DRAM controller has two working modes:

CO (Cache Only) mode: In a non-congestion scenario, the occupation rate of the Cache is less than TH, and in this case, the DRAM controller always works in CO mode, that is, all write data is stored in the on-chip cache and the CAM query of a read request is hit inevitably, and then the data is read from the on-chip cache. In this mode, no write request from the first interface 510 may enter a write request queue and no read request from the second interface 511 may enter a read request queue either, that is, no read or write request may access the off-chip DRAM.

WT (Write Through) mode: In a congestion scenario, read or write delay is so long that the occupation rate of the Cache exceeds TH and the DRAM controller may automatically switch to the WT mode. In this case, all write requests need to enter a WQ write request queue to access the off-chip DRAM; a read request may first query a CAM, and if the query is hit, data can still be read from the on-chip cache; if the query is not hit, the read request needs to enter an RQ read request queue to access the off-chip DRAM.

The above two modes may switch automatically according to the occupation rate of the Cache and switching is transparent to external modules. The mechanism of the switching is described as follows, where the threshold CO_TH1>CO_TH2:

CO→WT: After initialization, because the occupation rate of the Cache is 0, a default mode is the CO mode, and when the occupation rate of the Cache exceeds the threshold CO_TH1, a working mode switches to WT;

WT→CO: In the WT mode, if traffic drops or egress back pressure is removed, and as a result, the occupation rate of the Cache falls to below the threshold CO_TH2, the working mode switches back to CO.

The above TH1 and TH2 are both configurable. A different between TH1 and TH2 is to guarantee that the controller will not frequently switch between the CO and WT modes.

Optionally, the data management mode of the DRAM controller in the embodiment of the present invention may be preset to a priority awareness mode, and according to a data priority, the DRAM controller has two working modes:

CO (Cache Only, cache only) mode: No write request for high priority data from the first interface 510 may enter a write request queue, and no read request for high priority data from the second interface 511 may enter a read request queue either, that is, no read or write request may access the off-chip DRAM.

WT (Write Through, write through) mode: All write requests for low priority data need to enter a WQ write request queue to access the off-chip DRAM; a read request for low priority data may first query a CAM, and if the query is hit, data can still be read from the on-chip cache; if the query is not hit, the read request needs to enter an RQ read request queue to access the off-chip DRAM.

In the above two modes, automatic switching between CO and WT modes is implemented according to high and low priorities of data. The switching is transparent and not perceivable to external modules.

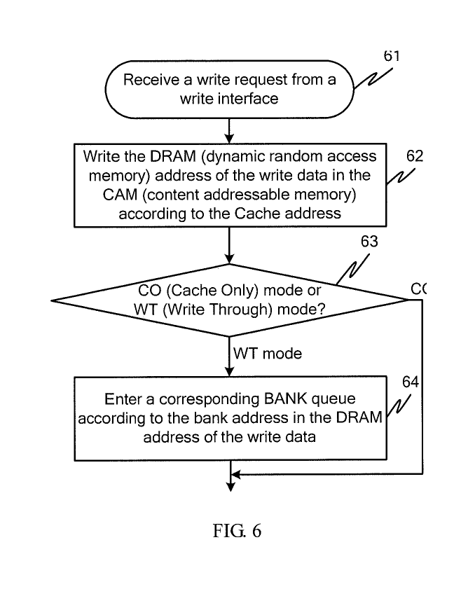

With reference to FIG. 5A and FIG. 5B, a procedure of the data management method in a write request direction in an embodiment of the present invention is shown in FIG. 6:

61. Receive a write request from a write interface, obtain a write data address (that is, an off-chip DRAM address) and write data, and apply a write cache address to write the write data in a Cache, that is, the write data address is an address of the write data in an off-chip DRAM.

62. Write the off-chip DRAM address of the write data in a CAM according to the Cache address. That is, the off-chip DRAM address of the write data in the CAM is the same as the address of the write data in the Cache.

63. Judge whether a working mode is a CO mode or a WT mode and if the working mode is the CO mode, end the procedure; if the mode is the WT mode, proceed to step 64.

64. If the working mode is the WT mode, the write request needs to enter a corresponding BANK queue according to a bank address in the off-chip DRAM address of the write data. Exemplarily, the off-chip DRAM address includes two parts. One part is a bank address, for example, 3 bits; the other part is a row and column address, for example, 20 bits. The request enters the BANK queue according to the bank address. The BANK queue is, for example, a BANK write request queue managed by a WQ_CTRL.

After step 64, the WQ_CTRL performs RR (Round-Robin, round-robin) scheduling on write requests in the BANK queue, and schedules the write requests to enter a wr_buf. An Arbiter obtains a write request from the wr_buf and sends the request to a PHY, to initiate a write operation to an off-chip DRAM.

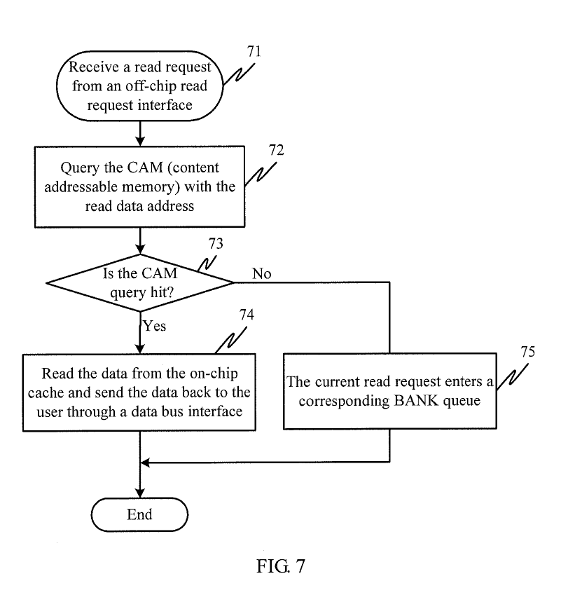

With reference to FIG. 5A and FIG. 5B, a procedure of the data management method in a read request direction in an embodiment of the present invention is shown in FIG. 7:

71. Receive a read request from an off-chip read request interface and obtain a read data address which is the address of read data in an off-chip DRAM.

72. Query a CAM with the read data address (that is, an off-chip DRAM address).

73. Judge whether a CAM query is hit and if the CAM query is hit, proceed to step 74, otherwise, proceed to step 75.

74. If the CAM query is hit, read the data from an on-chip cache, send the data through a data bus interface, and return the data to a user.

75. If the CAM query is not hit, it indicates that the read data is stored only in the off-chip DRAM and then a current read request enters a corresponding BANK queue. The BANK queue is, for example, a BANK read request queue managed by an RQ_CTRL.

After step 75, the RQ_CTRL performs RR scheduling on the read request BANK queue, and schedules the read request BANK queue to write the read request in an rr_buf. An Arbiter obtains the read request from the rr_buf and sends the request to a PHY, and sends a read operation to the off-chip DRAM; when the data is returned from the off-chip DRAM, the data is obtained from an asynchronous FIFO and the data is written in a Cache; and the data is read from the Cache and the data is sent back to a user through a data bus interface.

Persons of ordinary skill in the art understand that all or a part of steps in the methods according to the above embodiments can be implemented by a computer program instructing relevant hardware. The program may be stored in a computer readable storage medium and when the program is executed, steps in each method provided by the foregoing embodiments are executed. The storage medium may be a magnetic disk, a CD-ROM, a read-only memory (Read-Only Memory, ROM), or a random access memory (Random Access Memory, RAM).

What is claimed is:

1. A data management method, comprising:
receiving write data of a write request;
writing the write data according to a current data management mode, wherein when the data management mode is a first mode, the write data of the write request is stored in an on-chip cache; and when the data management mode is a second mode, the write data of the write request is stored in the on-chip cache and an off-chip memory chip; and
receiving a read request of the write data, searching for the write data in the on-chip cache according to the read request, and if the write data cannot be obtained from the on-chip cache, obtaining the write data from the off-chip memory chip.

2. The data management method according to claim 1, further comprising:
determining the data management mode according to a magnitude relationship between an occupation rate of the on-chip cache and a first preset threshold; or
determining the data management mode according to a data priority of the write data, wherein the data priority comprises a high priority or a low priority.

3. The data management method according to claim 2, wherein the determining the data management mode according to the magnitude relationship between the occupation rate of the on-chip cache and the preset threshold comprises:
when the occupation rate of the on-chip cache is less than or equal to the first threshold, determining that the data management mode is the first mode; and
when the occupation rate of the on-chip cache rises to be equal to or greater than the first threshold, determining that the data management mode is switched from the first mode to the second mode.

4. The data management method according to claim 3, wherein the determining the data management mode according to the magnitude relationship between the occupation rate of the on-chip cache and the preset threshold further comprises:
when the occupation rate of the on-chip cache drops from being greater than or equal to the first threshold to being less than or equal to a second threshold, determining that the data management mode is switched from the second mode to the first mode, wherein the first threshold is greater than the second threshold.

5. The data management method according to claim 2, wherein the determining the data management mode according to the data priority comprises:
when the data priority is a high priority, determining that the data management mode is the first mode; and
when the data priority is a low priority, determining that the data management mode is the second mode.

6. The data management method according to claim 2, wherein the determining the data management mode according to the data priority comprises:
when the data priority is a high priority and the occupation rate of the on-chip cache is equal to or greater than the first threshold, determining that the data management mode is the second mode.

7. A data management device, comprising:
a determining unit, configured to determine a data management mode according to an occupation rate of an on-chip cache or a priority of read or write data, wherein the data management mode comprises a first management mode and a second management mode;
a write request processing unit, configured to process a write request according to the data management mode, wherein when the data management mode is the first management mode, the write request processing unit writes write data of the write request in the on-chip cache, and when the data management mode is the second management mode, the write request processing unit writes write data of the write request in the on-chip cache and an off-chip memory chip; and
a read request processing unit, configured to: after receiving a read request, first search for read data of the read request in the on-chip cache, and if the read data does not exist in the on-chip cache, obtain the read data from the off-chip memory chip.

8. The data management device according to claim 7, wherein the determining unit comprises:
a first determining subunit, configured to determine that the data management mode is the first mode when the occupation rate of the on-chip cache is less than or equal to a first threshold; or
a first switching subunit, configured to determine that the data management mode is switched from the first mode to the second mode when the occupation rate of the on-chip cache rises to be equal to or greater than the first threshold; or
a second switching subunit, configured to determine that the data management mode is switched from the second mode to the first mode when the occupation rate of the on-chip cache returns to be less than or equal to a second threshold; wherein:
the first threshold is greater than the second threshold.

9. The data management device according to claim 7, wherein the determining unit comprises:
a second determining subunit, configured to determine that the data management mode is the first mode when a priority of the read or write data is a high priority; or
a third determining subunit, configured to determine that the data management mode is the second mode when a priority of the read of write data is a low priority.

10. A data chip, comprising:
an on-chip cache, configured to store read or write data;
a determining unit, configured to determine a data management mode according to an occupation rate of the on-chip cache or a priority of the read or write data, wherein the data management mode comprises a first management mode and a second management mode;
a write request processing unit, configured to process a write request according to the data management mode, wherein when the data management mode is the first management mode, the write request processing unit writes write data of the write request in the on-chip cache, and when the data management mode is the second management mode, the write request processing unit writes write data of the write request in the on-chip cache and an off-chip memory chip; and
a read request processing unit, configured to: after receiving a read request, first search for read data of the read request in the on-chip cache, and if the read data does not exist in the on-chip cache, obtain the read data from the off-chip memory chip.

11. The data chip according to claim 10, wherein: the determining unit comprises:
a first determining subunit, configured to determine that the data management mode is the first mode when the occupation rate of the on-chip cache is less than or equal to a first threshold; or
a first switching subunit, configured to determine that the data management mode is switched from the first mode to the second mode when the occupation rate of the on-chip cache rises to be equal to or greater than the first threshold; or
a second switching subunit, configured to determine that the data management mode is switched from the second mode to the first mode when the occupation rate of the on-chip cache returns to be less than or equal to a second threshold; wherein:
the first threshold is greater than the second threshold;
or, the determining unit comprises:
a second determining subunit, configured to determine that the data management mode is the first mode when a priority of the read or write data is a high priority; or
a third determining subunit, configured to determine that the data management mode is the second mode when a priority of the read or write data is a low priority.
